(19) United States
(12) Patent Application Publication
(10) Pub. No.: US 2019/0057048 A1
(43) Pub. Date: Feb. 21, 2019

(54) WIRELESS COMMUNICATION METHOD AND SYSTEM

(71) Applicant: MEDIATEK INC., Hsin-Chu (TW)

(72) Inventor: Chien-Hsiung CHANG, Hsin-Chu (TW)

(21) Appl. No.: 15/678,308

(22) Filed: Aug. 16, 2017

(51) Int. Cl. G06F 13/16; G06F 13/42

(52) U.S. Cl. CPC G06F 13/1642; G06F 13/1621; G06F 13/4286

(57) ABSTRACT

A wireless communication method and device are provided. The wireless communication system includes a communication interface, a transmitter and a receiver. The communication interface includes a plurality of lanes. The transmitter is coupled to the communication interface. The transmitter segments a plurality of input data into a plurality of packets of the same length, and transmits the packets with packet-based transmission through the plurality of lanes. The receiver is coupled to the communication interface and receives the packets from the plurality of lanes.

### BACKGROUND OF THE INVENTION

### Field of the Invention

The invention generally relates to a wireless communication technology, and more particularly, to a SerDes transmission based on a packet-based transmission.

### Description of the Related Art

In mobile communication systems, as data-rate requirements become more stringent, it is becoming increasingly difficult for a traditional I/Q interface between a radio frequency (RF) device (e.g. RF chip) and a baseband (BB) device (e.g. BB chip) to meet these requirements. One solution is to replace the I/Q interface with a Serializer/Deserializer (SerDes) interface. SerDes is a kind of high-speed serial data interface. A SerDes interface can consist of multiple lanes for very high data bandwidth requirements.

Based on the UniPro specification, in a conventional SerDes transmission, the transmitter (e.g. RF device) needs to perform a lane distribution operation, and the receiver (e.g. BB device) needs to perform a lane merge operation. Furthermore, when the number of lanes needs to be changed, an LC codeword will be utilized to inform the receiving side that the lane number needs to be changed. However, if the Lane Change (LC) codeword is lost, the merge operation in the receiver will be wrong. Furthermore, when the lane number is to be changed to increase, the new turn-on (or enabled) TX (transmitting side) and RX (receiving side) SerDes lanes need to exit the power saving state in advance to prepare for the changing lane numbers to transmit new (the next) data. Therefore, before the new data transmission, additional overhead or latency (including the transmission of the codewords LC, PREPARE, SYNC and PSYNC) will be generated.

### BRIEF SUMMARY OF THE INVENTION

A wireless communication system and method are provided to overcome the problems mentioned above.

An embodiment of the invention provides a wireless communication system. The wireless communication system comprises a communication interface, a transmitter and a receiver. The communication interface comprises a plurality of lanes. The transmitter is coupled to the communication interface. The transmitter segments a plurality of input data into a plurality of packets of the same length, and transmits the packets with packet-based transmission through the plurality of lanes. The receiver is coupled to the communication interface and receives the packets from the plurality of lanes.

In some embodiments, the transmitter further comprises a plurality of transmitting (TX) controllers. Each of the TX controllers corresponds to one respective lane of the plurality of lanes.

In some embodiments, the transmitter further comprises a queue manager device, a plurality of packet buffers and a plurality of data controllers. The plurality of data controllers are coupled to the queue manager device, and respectively coupled to the plurality of packet buffers. The plurality of data controllers segment the plurality of input data into the plurality of packets of the same length, store packet information of the packets to the queue manager device and store the data of the packets to the packet buffers. In some embodiments, the data controller stores the packet information of the packets to the queue manager device according to the priorities of the packets. In some embodiments, the queue manager device comprises high-priority queue storage and low-priority queue storage.

In some embodiments, the transmitter further comprises a lane controller. The lane controller calculates enabled input bandwidth according to the input data and decides how many lanes need to be enabled according to the enabled input bandwidth.

In some embodiments, the transmitter further comprises a scheduler. The scheduler is coupled to the plurality of TX controllers, the queue manager device and the lane controller. The scheduler selects transmission packets from the plurality of packets according to the packet information and the number of lanes decided by the lane controller. The scheduler schedules the transmission packets and transmits the scheduling result to the TX controllers. In some embodiments, if the high-priority queue storage is empty, the scheduler selects the transmission packets from the low-priority queue storage, and if the high-priority queue storage is not empty, the scheduler selects one transmission packet from the high-priority queue storage and selects other transmission packets from the low-priority queue storage.

In some embodiments, each of the TX controllers reads the data of the transmission packet from the packet buffer and transmits the data of the transmission packet and the packet information to the receiver through the respective lane. In some embodiments, the packet information comprises data length, sequence count and source-ID.

An embodiment of the invention provides a wireless communication method. The wireless communication method comprises the step of segmenting a plurality of input data into a plurality of packets of the same length; transmitting the packets with packet-based transmission through a plurality of lanes; and receiving the packets from the lanes of the communication interface.

Other aspects and features of the invention will become apparent to those with ordinary skill in the art upon review of the following descriptions of specific embodiments of wireless communication methods and devices.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the invention.

FIG. 2 is a block diagram of the wireless communication system 200 according to an embodiment of the invention.

FIG. 3A-3B is a schematic diagram of the wireless communication system 300 in the downlink path according to an embodiment of the invention.

FIG. 4 is a flow chart illustrating the enqueue flow of a data controller of a transmitter according to an embodiment of the invention.

FIG. 5A-5B is a flow chart illustrating the scheduling (dequeue) flow of a scheduler of a transmitter according to an embodiment of the invention.

FIG. 6 is a schematic diagram illustrating the packet scheduling according to an embodiment of the invention.

FIG. 7 is a schematic diagram illustrating a packet format according to an embodiment of the invention.

FIG. 8 is a flow chart illustrating the wireless communication method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

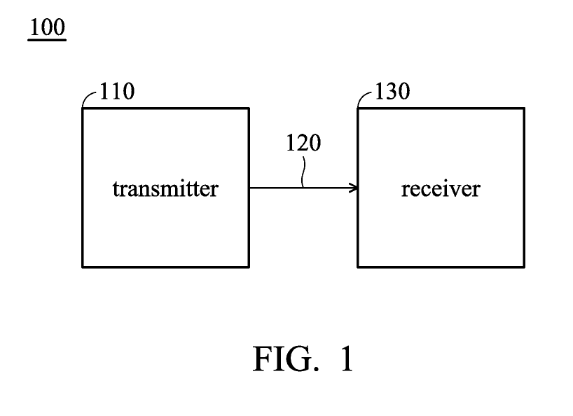

FIG. 1 is a block diagram of a wireless communication system 100 according to an embodiment of the invention. The wireless communication system 100 comprises a transmitter 110, a communication interface 120 and a receiver 130. Note that, in order to clarify the concept of the invention, FIG. 1 presents a simplified block diagram in which only the elements relevant to the invention are shown. However, the invention should not be limited to what is shown in FIG. 1.

In the embodiments of the invention, the communication interface 120 may be a high-speed serial communication interface, such as a serializer/deserializer (SerDes). The communication interface 120 may comprise a plurality of lanes. It should be noted that the transmitter 110 and receiver 130 may be devices which are configured to have both reception and transmission capabilities. However, to better focus on aspects of this disclosure, only the unidirectional transfer of information is shown.

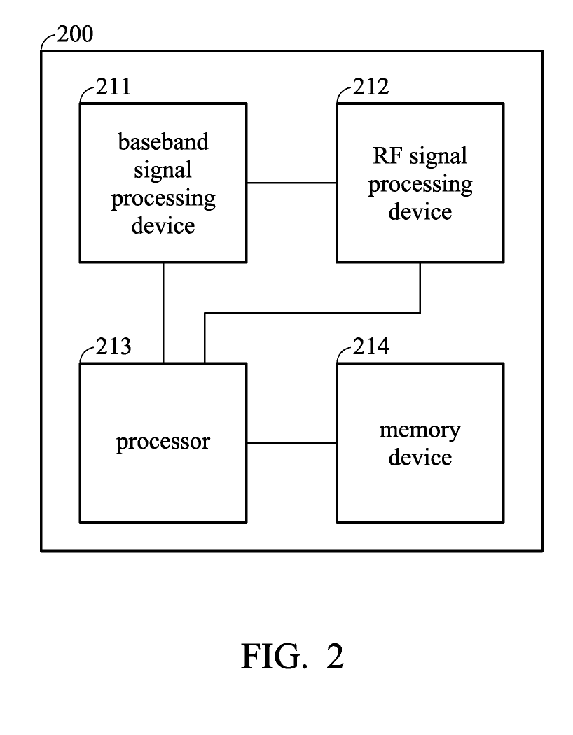

In an embodiment of the invention, in the downlink (DL) path, the transmitter 110 may be a radio frequency (RF) signal processing device (or an RF chip) and the receiver 130 may be a baseband (BB) signal processing device (or a BB chip). In another embodiment of the invention, in the uplink (UL) path, the transmitter 110 may be a baseband signal processing device and the receiver 130 may be an RF signal processing device. Details are discussed in FIG. 2 below.

FIG. 2 is a block diagram of the wireless communication system 200 according to an embodiment of the invention. The wireless communication system 200 can be regarded as the wireless communication system 100, the RF signal processing device 212 can be regarded as the transmitter 110 (or receiver 130) and the baseband signal processing device 211 can be regarded as the receiver 130 (or transmitter 110). In the embodiments of the invention, the wireless communication system 200 may be a mobile communications device, such as a cellular phone, a smartphone, a laptop stick, a mobile hotspot, a USB modem, a tablet, etc.

As shown in FIG. 2, the wireless communication system 200 comprises at least a baseband signal processing device 211, an RF signal processing device 212, a processor 213, a memory device 214, and an antenna module comprising at least one antenna. Note that, in order to clarify the concept of the invention, FIG. 2 presents a simplified block diagram in which only the elements relevant to the invention are shown. However, the invention should not be limited to what is shown in FIG. 2.

The RF signal processing device 212 may receive RF signals via the antenna and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital converter (ADC)/digital-to-analog converter (DAC), etc.

The baseband signal processing device 211 may further process the baseband signals to obtain information or data transmitted by the peer communications apparatus. The baseband signal processing device 211 may also comprise a plurality of hardware elements to perform baseband signal processing. The baseband signal processing may comprise gain adjustment, modulation/demodulation, encoding/decoding, and so on. The baseband signal processing device 211 may also comprise a digital front end (DFE) module.

The processor 213 may control the operations of the baseband signal processing device 211 and the RF signal processing device 212. According to an embodiment of the invention, the processor 213 may also be arranged to execute the program codes of the software module(s) of the corresponding baseband signal processing device 211 and/or the RF signal processing device 212. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software module(s).

The memory device 214 may store the software and firmware program codes, system data, user data, etc. of the wireless communication system 200. The memory device 214 may be a volatile memory such as a Random Access Memory (RAM); a non-volatile memory such as a flash memory or Read-Only Memory (ROM); a hard disk; or any combination thereof.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the communication system 200 may be extended further to comprise more than one antenna and/or more than one radio module, and the invention should not be limited to what is shown in FIG. 2.

In addition, in some embodiments of the invention, the processor 213 may be configured inside of the baseband signal processing device 211, or the communication system 200 may comprise another processor configured inside of the baseband signal processing device 211. Thus the invention should not be limited to the architecture shown in FIG. 2.

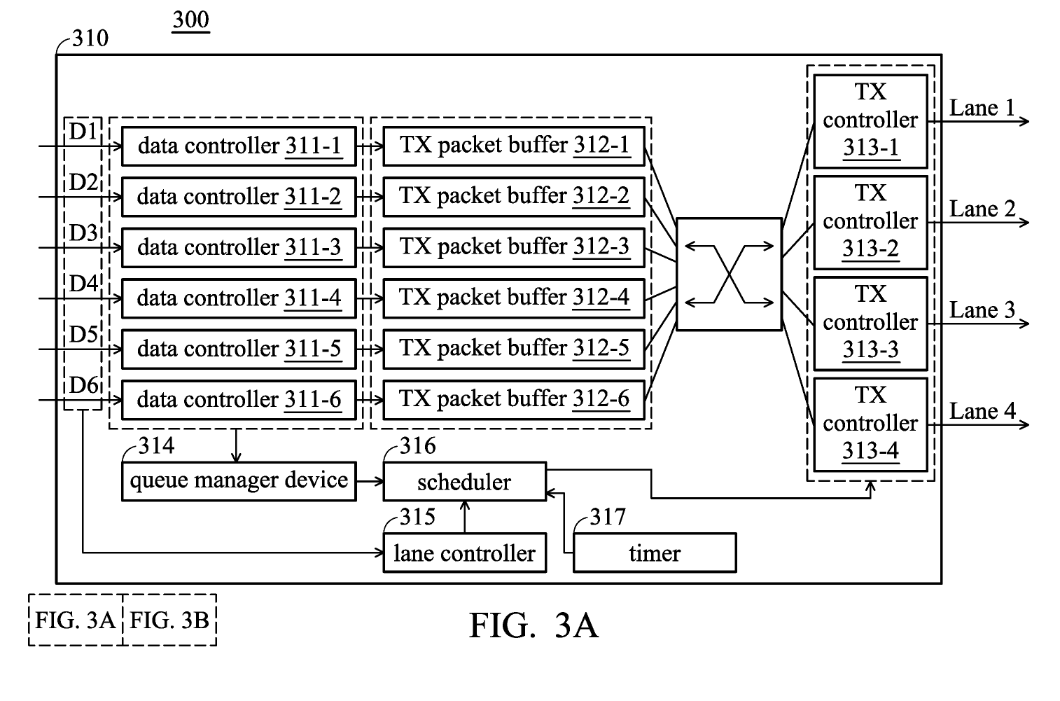

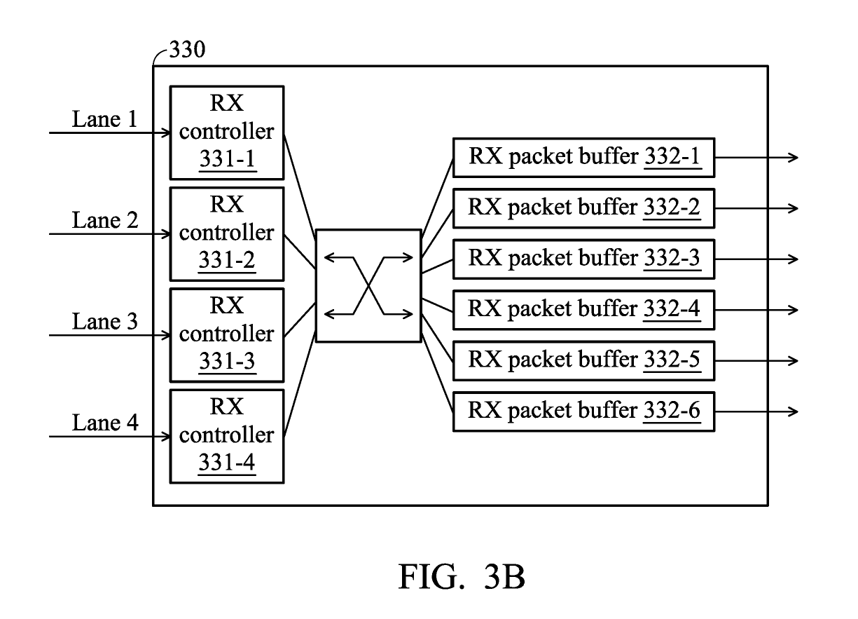

FIG. 3A-3B is a schematic diagram of the wireless communication system 300 in the downlink path according to an embodiment of the invention. The wireless communication system 300 can be applied to the wireless communication system 100 and 200 shown in FIG. 1 and FIG. 2. Note that, in order to clarify the concept of the invention, FIG. 3A-3B presents a simplified block diagram in which only the elements relevant to the invention are shown. However, the invention should not be limited to what is shown in FIG. 3A-3B. Furthermore, the wireless communication of the wireless communication system 300 in the uplink path is the same as it in downlink path. Thus, the invention will not discuss it more.

As shown in FIG. 3A-3B, the RF signal processing device 310 may comprise the data controllers 311-1˜311-6, the TX packet buffers 312-1˜312-6, the TX controllers 313-1˜313-4, a queue manager device 314, a lane controller 315, a scheduler 316 and a timer 317. The communication interface 320 comprises four lanes, Lane 1, Lane 2, Lane 3 and Lane 4. The receiver 330 comprises RX controllers 331-1˜331-4 and RX packet buffers 332-1˜332-6. Note that, the number of data controllers, TX packet buffers, TX controllers, lanes, RX controllers, and RX packet buffers should not be limited to what is shown in FIG. 3A-3B.

In an embodiment of the invention, when the data controllers 311-1˜311-6 receive the input data D1˜D6, the data controllers (or I/Q controllers) 311-1˜311-6 may respectively store the input data D1˜D6 in the TX packet buffers 312-1˜312-6. The input data D1˜D6 may be received by the antennas of the RF signal processing device 310 and then transmitted to the data controllers 311-1˜311-6 respectively corresponding to different paths. In addition, the input data D1˜D6 may be pre-processed by the analog-to-digital converter.

When the data controllers 311-1˜311-6 receives the input data D1˜D6, the data controllers 311-1˜311-6 may segment the input data D1˜D6 into a plurality of packets of the same fixed length. For example, in the path corresponding to the data controller 311-1, when the data controller 311-1 receives the input data D1, the data controller 311-1 may store the input data D1 in the packet buffers 312-1 and segment the input data D1 into a plurality of packets of the same fixed length. That is to say, in the invention, the transmission on the lanes is based on the packet-based transmission, i.e. the transmission unit on the lane is one packet.

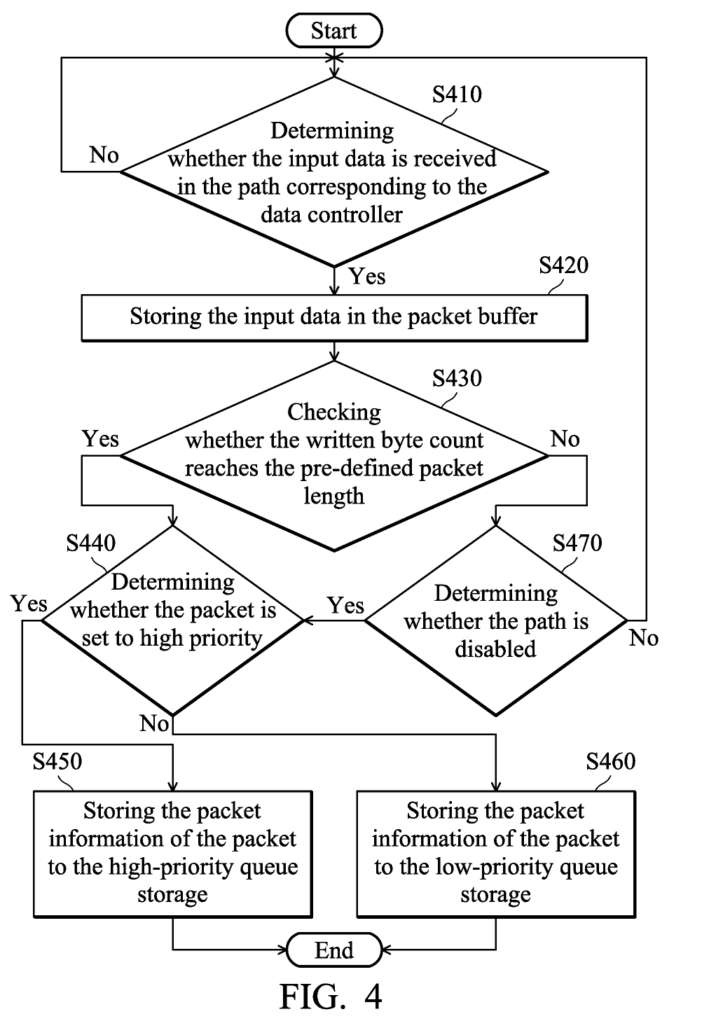

When the packets are generated, the data controllers 311-1˜311-6 may store the packet information of the packets in the queue manager device 314. It means that the data controllers 311-1˜311-6 may enqueue the packets in the queue manager device 314 and when the packets are enqueued, the data controllers 311-1˜311-6 may store (write) the related packet information of the packets in the queue manager device 314. In an embodiment of the invention, the queue manager device 314 may comprise high-priority queue storage and low-priority queue storage. The data controllers 311-1˜311-6 may enqueue the packets in the queue manager device 314 according to the priorities of the packets. In the enqueue flow, the packet with high priority may be stored (or written) in the high-priority queue storage and the packet with low priority may be stored (or written) in low-priority queue storage. For example, the voice data may be set to high priority for scheduling, thus, the packet corresponding to the voice data may be stored in the high-priority queue storage. The details of enqueue flow of the data controllers are discussed in FIG. 4. In an embodiment of the invention, the packet information may comprise the data length, sequence count and source-ID. The data length means the length of the packet. The sequence count means the enqueue order (number) of the packet which is utilized for error detection. The source-ID means the ID of the packet.

FIG. 4 is a flow chart illustrating the enqueue flow of a data controller of a transmitter according to an embodiment of the invention. The enqueue flow can be applied to the data controllers 311-1˜311-6. In step S410, the data controller determines whether the input data is received in the path corresponding to the data controller. If the input data receives the input data, step S420 is performed. In step 420, the data controller may store (or write) the input data in the packet buffer.

Then, in step S430, the data controller may check whether the written byte count reaches the pre-defined packet length (i.e. the data controller may segment the input data into the packets according to the pre-defined packet length). When the written byte count reaches the pre-defined packet length, step S440 is performed. In step S440, the data controller may determine whether the packet is set to high priority. If the packet is set to high priority step S450 is performed. In step S450, the data controller may store (write) the packet information of the packet to the high-priority queue storage. If the packet is not set to high priority step S460 is performed. In step S460, the data controller may store (write) the packet information of the packet to the low-priority queue storage.

When the written byte count does not reach the pre-defined packet length, step S470 is performed. In step S470, the data controller may determine whether the path is disabled (i.e. no other input data may be received in the path corresponding to the data controller). If the path is not disabled, the data controller may back to step S410 to wait for the other data. If the path is disabled, the data controller may directly perform step S440, even though the length of the last packet does not reach the pre-defined packet length.

Backing to FIG. 3A-3B, the lane controller 315 may calculate enabled input bandwidth (or total input data rates) according to the input data D1˜D6 and decide how many lanes need to be enabled according to the enabled input bandwidth. Then, the lane controller 315 may transmit the decision (e.g. only Lane 1 and Lane 2 need to be enabled) to the scheduler 316. That is to say, the lane controller 315 may decide which lane(s) need to be enabled and which lane(s) need to be disabled and the scheduler 316 will know the number of packets which need to be scheduled in the current scheduling interval according to the decision. When the enabled input bandwidth is increased or decreased, the lane controller 315 can decide the number of lanes that need to be enabled. Therefore, in the embodiments of the invention, the lane controller 315 can directly decide how many lanes need to be enabled in each scheduling interval according to the enabled input bandwidth (or total input data rates) without needing to transmit an LC codeword in advance when the number of lanes needs to be changed.

The scheduler 316 is coupled to the plurality of TX controllers 313-1-313-4, the queue manager device 314 and the lane controller 315. In the scheduling (dequeue) flow, the scheduler 316 may select the transmission packets from the plurality of packets according to the packet information and the decision of the lane controller 315. The transmission packets mean that the packets need to be transmitted in a scheduling interval. The residual packets which are not selected in the scheduling interval may be selected in the next scheduling intervals. In the embodiment of the invention, the RF signal processing device 310 comprises the timer 317. The timer 317 may be coupled with the scheduler 316 and be utilized to count the scheduling intervals. When the timer value of the timer 317 reaches the pre-defined scheduling interval length, the timer 317 may re-count the timer value for next scheduling interval.

The scheduling interval I means that the time for transmitting one packet, and it is defined based on the equation below:

I=(H+L)*(1+SOH)/SDR,

wherein the L is the packet length, H is the packet header size, SOH is serial interface (e.g. SerDes) overhead for encode, and SDR is the serial interface data rate (i.e. the data rate of the lane).

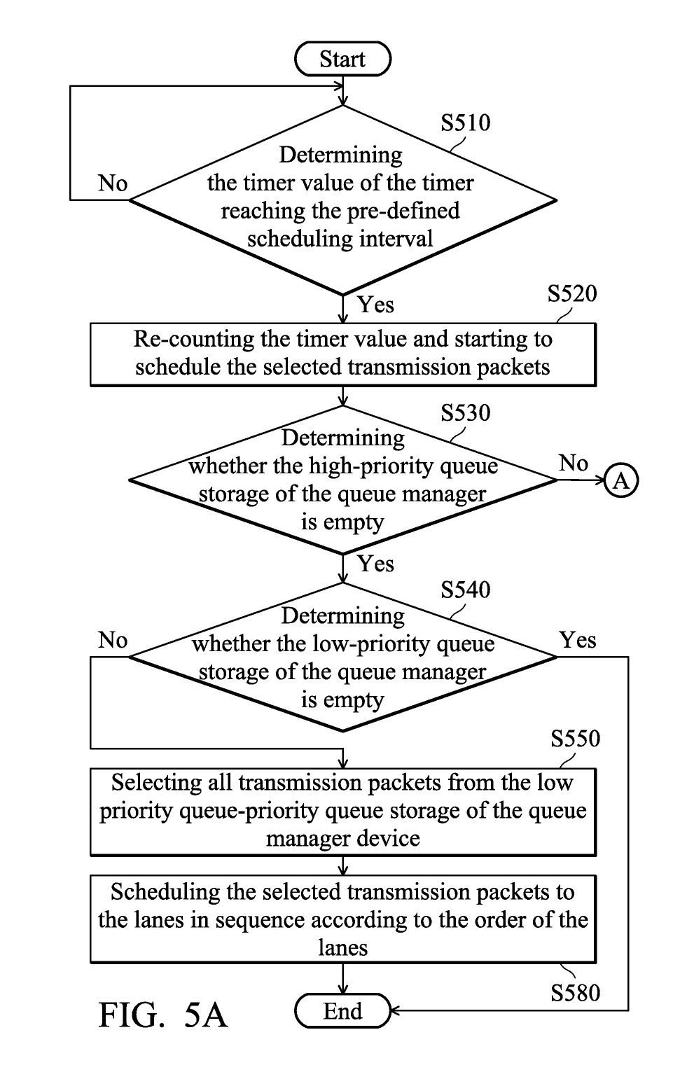

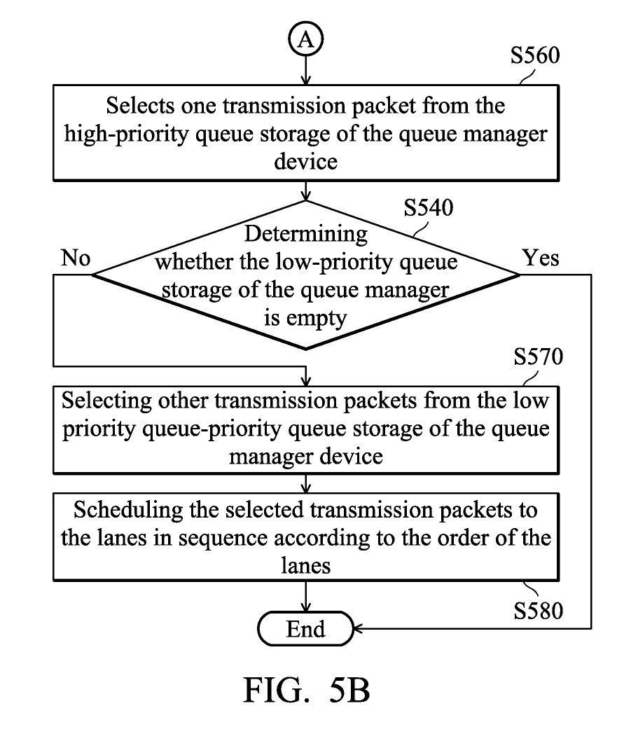

The scheduler 316 may schedule the selected transmission packets and transmit the scheduling result to the TX controllers 313-1-313-4. In an embodiment of the invention, if the high-priority queue storage of the queue manager device 314 is empty, the scheduler 316 may select all transmission packets from the low-priority queue storage of the queue manager device 314, and if the high-priority queue storage of the queue manager device 314 is not empty, the scheduler may select one transmission packet from the high-priority queue storage of the queue manager device 314 first and then select other transmission packets from the low-priority queue storage of the queue manager device 314. The details of scheduling (dequeue) flow of the data controllers are illustrated in FIG. 5A-5B.

FIG. 5A-5B is a flow chart illustrating the scheduling (dequeue) flow of a scheduler of a transmitter according to an embodiment of the invention. The scheduling flow can be applied to the scheduler 316. In step S510, the scheduler determines the timer value of the timer reaching the pre-defined scheduling interval (i.e. determining whether the prior selected transmission packets have been transmitted to the receiver). If the timer value of the timer has reached the pre-defined scheduling interval (i.e. the prior selected transmission packets have been transmitted to the receiver and other selected transmission packets corresponding to the next scheduling interval will be scheduled and transmitted), step S520 is performed. In step S520, the timer re-counts the timer value and the scheduler may start to schedule the selected transmission packets. In step S530, the scheduler determines whether the high-priority queue storage of the queue manager device is empty. If the high-priority queue storage of the queue manager device is empty, step S540 is performed. In step S540, the scheduler determines whether the low-priority queue storage of the queue manager device is empty. If the low-priority queue storage of the queue manager device is not empty, step S550 is performed. In step S550, the scheduler selects all transmission packets from the low-priority queue storage of the queue manager device. If the low-priority queue storage of the queue manager device is also empty, the scheduling flow ends.

If the high-priority queue storage of the queue manager device is not empty, step S560 is performed. In step S560, the scheduler selects one transmission packet from the high-priority queue storage of the queue manager device. Then, the scheduler performs step S540 to determine whether the low-priority queue storage of the queue manager device is empty. If the low-priority queue storage of the queue manager device is not empty, step S570 is performed. In step S570, the schedule selects other transmission packets from the low-priority queue storage of the queue manager device.

In step S580, the scheduler schedules (or assigns) the selected transmission packets to the lanes in sequence according to the order of the lanes (i.e. from small lane number to large lane number). For example, if the selected transmission packets in sequence are the packet A, packet B, packet C and packet D, the scheduler may schedule the packet A to lane 1, schedule the packet B to lane 2, schedule the packet C to lane 3 and schedule the packet D to lane 4.

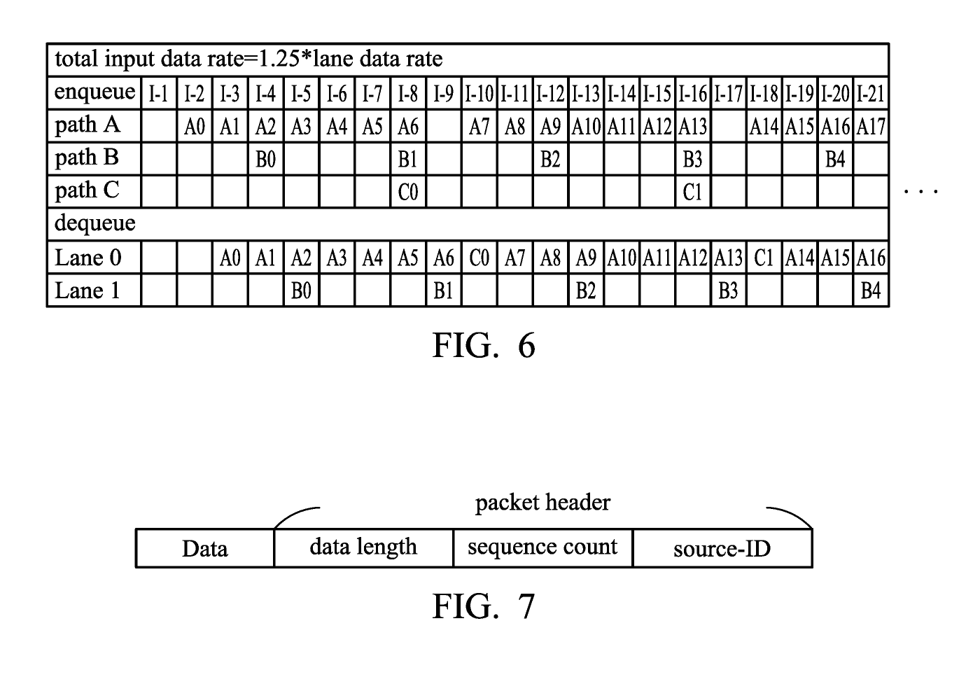

In an embodiment of the invention, when the scheduler 316 schedules the selected transmission packets the packets, the scheduler 316 may keep the lane with the lowest lane number as busy as possible to save power in other lanes. For example, if lane 0 and lane 1 are enabled, the scheduler 316 may keep lane 0 as busy as possible. FIG. 6 will be used as an example for illustration.

FIG. 6 is a schematic diagram illustrating the packet scheduling according to an embodiment of the invention. As shown in FIG. 6, I-1˜I-21 means the scheduling intervals A0˜A17, B0˜B4 and C0˜C1 are packets. Furthermore, in dequeue flow, the empty blanks means that there are no packets for transmission. In FIG. 6, it is assumed that in enqueue flow, the data rate of the path A is ⅞*lane data rate (i.e. 7 packets may be transmitted in 8 scheduling intervals), the data rate of the path B is ¼*lane data rate (i.e. 1 packets may be transmitted in 4 scheduling intervals) and the data rate of the path C is ⅛*lane data rate (i.e. 1 packets may be transmitted in 8 scheduling intervals) and the packets A0˜A17 have a high priority. The total input data rate (enabled input bandwidth) is 1.25*lane data rate. Thus, the lane controller may decide to enable two lanes, Lane 0 and Lane 1 for transmission. As shown in FIG. 6, the scheduler may keep the lane 0 as busy as possible to save power in Lane 1 (e.g. the packets C0˜C1 are transmitted only by Lane 1). When there is no packet which needs to be transmitted by Lane 1 in the current scheduling interval, the Lane 1 can enter a power saving mode (e.g. STALL mode) to save power. In conventional SerDes transmission, if the Lane 0 and Lane 1 are enabled, the Lane 0 and Lane 1 need to do the same operation. That is to say, Lane 0 and Lane 1 need to transmit packets at the same time and enter the power saving mode at the same time. Therefore, more overhead (because the codewords need to be transmitted) of the SerDes transmission will be generated. However, in the transmission mechanism of the invention, the overhead of the SerDes transmission will be reduced because the Lane 0 does not need to enter the power saving mode with Lane 1 at the same time.

Backing to FIG. 3A-3B, each of the TX controllers 313-1-313-4 corresponds to one respective lane of the plurality of lanes. Namely, in the embodiments of the invention, one TX controller may be configured to one lane. For example, TX controller 313-1 is configured to Lane 1, TX controller 313-2 is configured to Lane 2, TX controller 313-3 is configured to Lane 3 and TX controller 313-4 is configured to Lane 4. When the TX controllers 313-1-313-4 receive the scheduling result from the scheduler 316, the TX controllers 313-1-313-4 may read the data of the transmission packets from the TX packet buffers 312-1˜312-6 and read the packet information of the transmission packets from the queue manager device 314 according to the scheduling result. For example, the scheduling result indicates that TX controller 313-1 is configured to transmit packet A, TX controller 313-2 is configured to transmit packet B, TX controller 313-3 is configured to transmit packet C and TX controller 313-4 is configured to transmit packet D, the TX controllers 313-1-313-4 may respectively read the data of the transmission packets A, B, C and D from the TX packet buffers 312-1˜312-6 and read the packet information of the transmission packets A, B, C and D from the queue manager device 314.

Furthermore, in an embodiment of the invention, the TX controllers 313-1-313-4 may add the packet header to the transmission packet according to the packet information of the transmission packet to form a packet format. Namely, the packet header may comprise the data length, sequence count and source-ID of the transmission packet. As shown in FIG. 7, a packet format of the real transmission packet may comprise two parts. One part is the data of the transmission packet and the other part is the packet header of the transmission packet. Then, the TX controllers 313-1-313-4 may respectively transmit the transmission packets which have been added the packet headers to the RX controllers 331-1˜331-4 through the Lane 1, Lane 2, Lane 3 and Lane 4.

Each of the RX controllers 331-1˜331-4 corresponds to one respective lane of the plurality of lanes. Namely, one RX controller may be configured to one lane. For example, RX controller 331-1 is configured to Lane 1, RX controller 331-2 is configured to Lane 2, RX controller 331-3 is configured to Lane 3 and TX controller 331-4 is configured to Lane 4. When the RX controllers 331-1˜331-4 receive the transmission packets which have been added the packet headers from the TX controllers 313-1-313-4, the RX controllers 331-1˜331-4 may store (or write) the data of the transmission packets to the RX packet buffers 332-1˜332-6 according to the packet information in the packet headers. For example, the RX controllers 331-1˜331-4 may store (or write) the data of the transmission packet to the RX packet buffers 332-1˜332-6 according to the data length and the source-ID of the transmission packet. Furthermore, the RX controllers 331-1˜331-4 can check whether the packet is lost according to result of the received the sequence count.

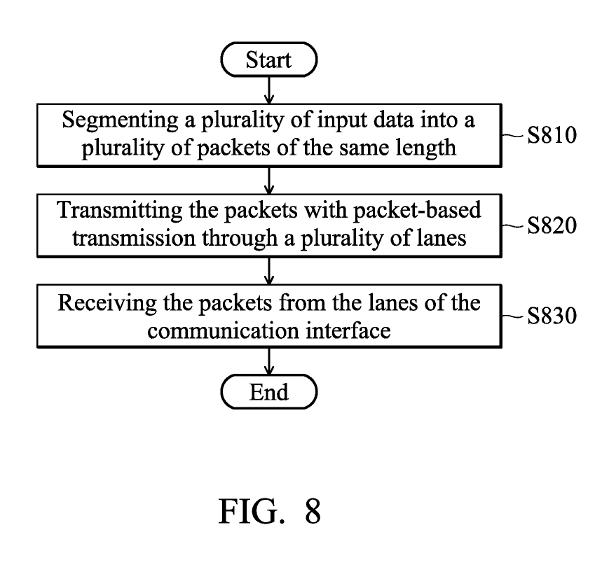

FIG. 8 is a flow chart illustrating the wireless communication method according to an embodiment of the invention. The wireless communication method is applied to the wireless communication system 100, 200 and 300. First, in step S810, a transmitter segments a plurality of input data into a plurality of packets of the same length. In step S820, the transmitter transmits the packets with packet-based transmission through a plurality of lanes. In step S830, a receiver receives the packets from the lanes of the communication interface.

In some embodiments of the invention, when the transmitter segments a plurality of input data into a plurality of packets of the same length, the wireless communication method further comprises the step of storing packet information of the packets to a queue manager device, and storing the data of the packets to packet buffers. In some embodiments of the invention, the transmitter stores the packet information of the packets to the queue manager device according to the priorities of the packets. The queue manager device may comprise high-priority queue storage and low-priority queue storage.

In some embodiments of the invention, the wireless communication method further comprises the steps of calculating enabled input bandwidth according to the input data by the transmitter and deciding how many lanes need to be enabled according to the enabled input bandwidth by the transmitter.

In some embodiments of the invention, the wireless communication method further comprises the steps of selecting transmission packets from the plurality of packets according to the packet information and the number of lanes, scheduling the transmission packets and transmitting the scheduling result to the TX controllers of the transmitter. In some embodiments of the invention, if the high-priority queue storage is empty, the packets are selected from the low-priority queue storage; and if the high-priority queue storage is not empty, one packet is selected from the high-priority queue storage and other packets which need to be selected are selected from the low-priority queue storage.

In some embodiments of the invention, the wireless communication method further comprises the steps of reading the data of the transmission packet from the packet buffer, and transmitting the data of the transmission packet and the packet information to the receiver through the respective lane. In some embodiments of the invention, the wireless communication method further comprises the steps of generating a packet format according to the data of the transmission packet and the packet information.

In the wireless communication method of the invention, the lane distribution operation and lane merge operation will not need to be performed. Furthermore, in the wireless communication method of the invention, when lane number needs to be changed, the transmitter can directly decide how many lanes need to be enabled in each scheduling interval without needing to transmit LC codeword in advance to avoid the LC codeword being lost. Furthermore, in the wireless communication method of the invention, the transmitter may keep the lane with the lowest lane number as busy as possible to save power in other lanes.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communication system, comprising:
a communication interface, comprising a plurality of lanes;
a transmitter, coupled to the communication interface, segmenting a plurality of input data into a plurality of packets of the same length, and transmitting the packets with packet-based transmission through the plurality of lanes; and
a receiver, coupled to the communication interface, receiving the packets from the plurality of lanes.

2. The wireless communication system of claim 1, wherein the transmitter further comprises:
a plurality of transmitting (TX) controllers, wherein each of the TX controllers corresponds to one respective lane of the plurality of lanes.

3. The wireless communication system of claim 2, wherein the transmitter further comprises:
a queue manager device;
a plurality of packet buffers; and
a plurality of data controllers, coupled to the queue manager device, respectively coupled to the plurality of packet buffers, segmenting the plurality of input data into the plurality of packets of the same length, storing packet information of the packets to the queue manager device and storing the data of the packets to the packet buffers.

4. The wireless communication system of claim 3, wherein the data controller stores the packet information of the packets to the queue manager device according to the priorities of the packets.

5. The wireless communication system of claim 4, wherein the queue manager device comprises high-priority queue storage and low-priority queue storage.

6. The wireless communication system of claim 5, wherein the transmitter further comprises:
a lane controller, calculating enabled input bandwidth according to the input data and deciding how many lanes need to be enabled according to the enabled input bandwidth.

7. The wireless communication system of claim 6, wherein the transmitter further comprises:
a scheduler, coupled to the plurality of TX controllers, the queue manager device and the lane controller, and selecting transmission packets from the plurality of packets according to the packet information and the number of lanes decided by the lane controller, scheduling the transmission packets, and transmitting the scheduling result to the TX controllers.

8. The wireless communication system of claim 7, wherein if the high-priority queue storage is empty, the scheduler selects the transmission packets from the low-priority queue storage, and if the high-priority queue storage is not empty, the scheduler selects one transmission packet from the high-priority queue storage and selects other transmission packets from the low-priority queue storage.

9. The wireless communication system of claim 8, wherein each of the TX controllers reads the data of the transmission packet from the packet buffer and transmits the data of the transmission packet and the packet information to the receiver through the respective lane.

10. The wireless communication system of claim 3, wherein the packet information comprises data length, sequence count and source-ID.

11. A wireless communication method, comprising:
segmenting, by a transmitter, a plurality of input data into a plurality of packets of the same length;
transmitting, by the transmitter, the packets with packet-based transmission through a plurality of lanes; and
receiving, by a receiver, the packets from the lanes of the communication interface.

12. The wireless communication method of claim 11, wherein the transmitter comprises a plurality of transmitting (TX) controllers and each of the TX controllers corresponds to one respective lane of the plurality of lanes.

13. The wireless communication method of claim 12, further comprising:
storing packet information of the packets to a queue manager device; and
storing the data of the packets to packet buffers.

14. The wireless communication method of claim 13, further comprising:
storing the packet information of the packets to the queue manager device according to the priorities of the packets.

15. The wireless communication method of claim 14, wherein the queue manager device comprises high-priority queue storage and low-priority queue storage.

16. The wireless communication method of claim 15, further comprising:
calculating enabled input bandwidth according to the input data; and
deciding how many lanes need to be enabled according to the enabled input bandwidth.

17. The wireless communication method of claim 16, further comprising:
selecting transmission packets from the plurality of packets according to the packet information and the number of lanes;
scheduling the transmission packets; and
transmitting the scheduling result to the TX controllers.

18. The wireless communication method of claim 17, further comprising:
if the high-priority queue storage is empty, selecting the transmission packets from the low-priority queue storage; and
if the high-priority queue storage is not empty, selecting one transmission packet from the high-priority queue storage and selecting other transmission packets from the low-priority queue storage.

19. The wireless communication method of claim 18, further comprising:
reading the data of the transmission packet from the packet buffer; and
transmitting the data of the transmission packet and the packet information to the receiver through the respective lane.

20. The wireless communication method of claim 13, wherein the packet information comprises data length, sequence count, and source-ID.
